(19) United States
(12) Patent Application Publication
(10) Pub. No.: US 2026/0268417 A1
(43) Pub. Date: Sep. 10, 2026

(54) AGENTIC SYSTEM INTERFACE FOR TAX APPLICATION AGENTS

(71) Applicant: Vertex, Inc., King of Prussia, PA (US)

(72) Inventor: Christopher Zangrilli, Annville, PA (US)

(21) Appl. No.: 19/438,356

(22) Filed: Dec. 31, 2025

Related U.S. Application Data
(60) Provisional application No. 63/768,045, filed on Mar. 6, 2025.

(51) Int. Cl. G06Q 40/12; G06F 16/3329

(52) U.S. Cl. CPC G06Q 40/123; G06F 16/3329

(57) ABSTRACT

A computing system for interfacing a tax application agentic system with a client application agentic system includes processing circuitry that implements a tax application on a first computing device and a client application on a second computing device. The processing circuitry is configured to receive a tax-related query at the second computing device that requiring instantiation of one or more tax application agents at the first computing device, implement an application programming interface that enables registration of the one or more tax application agents at the first computing device with the second computing device, implement an orchestration agent included in a client application agentic system at the second computing device to access and direct the one or more tax application agents at the first computing device to assist in responding to the query via the application programming interface, and output, at the second computing device, a response to the query.

### CROSS REFERENCE TO RELATED APPLICATIONS

The present application is based upon and claims priority under 35 U.S.C. 119 (e) to U.S. Provisional Patent Application Ser. No. 63/768,045 filed Mar. 6, 2025, the entirety of which is hereby incorporated herein by reference for all purposes.

### BACKGROUND

In the modern tax information ecosystem, global businesses that sell goods and services in a variety of countries and localities, either online or via physical stores, typically configure their point of sale and/or enterprise resource management computing systems to engage with enterprise tax technology provider platforms that automate and digitize preparation of tax returns and filings to the various local tax authorities, thereby ensuring global compliance with tax laws. These same businesses typically use various other enterprise-ware solutions to manage parts of their business. For example, some businesses use customer relationship management platforms, other businesses use inventory and logistics management software, other businesses use point of sale software, and yet other businesses use invoicing software. In their enterprise tax technology provider platforms and enterprise-ware systems, businesses can find their data is siloed.

Language models have been developed that can be leveraged to provide users with a natural language interface for answering questions. To expand the functionality of language models, artificial intelligence agentic machine learning systems have been proposed that respond to a user's query received via a language model chat interface by employing one or more language model agents configured perform certain specialized tasks defined in a workflow. To date, the application of such language models and agentic systems to tax technology has been limited.

### SUMMARY

To address these issues and others described herein, systems and methods for interfacing a tax application agentic system on a first computing system with a client application agentic system on a second computing system are provided. According to one aspect, a computing system comprises processing circuitry configured to execute instructions using portions of associated memory to implement a tax application on a first computing device and a client application on a second computing device. The processing circuitry is configured to receive a tax-related query at the second computing device. The tax-related query requires instantiation of one or more tax application agents included in a tax application agentic system at the first computing device. The processing circuitry is further configured to implement an application programming interface that enables registration of the one or more tax application agents at the first computing device with the second computing device. The processing circuitry is further configured to implement an orchestration agent included in a client application agentic system at the second computing device to access and direct the one or more tax application agents at the first computing device to assist in responding to the tax-related query via the application programming interface. The processing circuitry is further configured to output, at the second computing device, a response to the tax-related query.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of a computing system including a client computing device implementing client application agentic system that is configured to interface with a tax application agentic system.

FIG. 2 shows a schematic diagram of a graphical user interface, in accordance with the computing system of FIG. 1.

FIG. 3 shows a schematic diagram of calls between a client computing device and a server computing device as facilitated by an application programing interface, in accordance with the computing system of FIG. 1.

FIG. 4 shows a flowchart for a method for interfacing a tax application agentic system with a client application agentic system, according to an example implementation.

FIG. 5 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods or to perform activities. Tax applications can help clients manage customers and handle the complexities of determining tax rates for different products, as well as for different vendors and locations. However, a user may desire to determine tax-related information while working within a client, i.e., third party, application.

The embodiments described herein relate to implementing a client application agentic system to interface with a tax application agentic system. Artificial intelligence agents from a tax application are registered at a client device such that a client orchestration agent can access the tax application agents to assist in answering tax-related queries in a federated manner.

While the embodiments disclosed herein are described in the context of a tax application, the concept of context-aware virtual assistance may be implemented in any suitable type of application, such as applications for communication, entertainment, productivity, education, security, and finance.

It will be appreciated that the example implementations described herein and with reference to the figures are exemplary in nature and are thus not intended to limit the scope of the disclosure, as numerous variations of the provided implementations are possible.

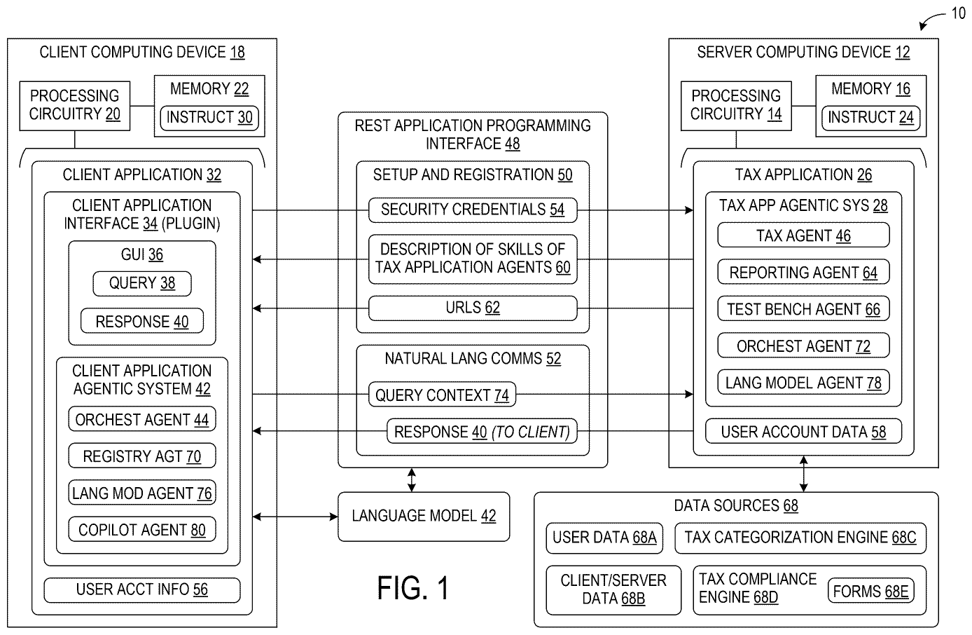

To address the issues described above, a computing system for interfacing a client application agentic system with a tax application agentic system is provided. As shown in FIG. 1, the computing system 10 includes a first computing device 12 with processing circuitry 14 and associated memory 16, and a second computing device 18 with processing circuitry 20 and associated memory 22. As disclosed herein, the first computing device will be described as a server computing device 12, and the second computing device will be described as a client computing device 18. It will be appreciated that in other configurations, the computing system 10 may include a single computing device that carries out the salient functions of both the server 12 and client computing device 18, and that the first computing device could be a computing device other than server. In other alternative configurations, functions described as being carried out at the server 12 may alternatively be carried out at the client computing device 18 and vice versa. It will be further appreciated that the client computing device as described herein may be any type of third-party computing device.

Continuing with FIG. 1, the memory 16 stores instructions 24 that cause the processing circuitry 14 to execute a tax application 26, including a tax application agentic system 28. It will be appreciated that distributed processing strategies may be implemented to execute the tax application 26 described herein, and the processing circuitry 14 therefore may include multiple physical processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example.

Similarly, the memory 22 of the client computing device 18 stores instructions 30 that cause the processing circuitry 20 to execute a client application 32, including a client application interface 34 and a graphical user interface (GUI) 36. As with the tax application 26, distributed processing strategies may be implemented to execute the client application 32 described herein, and the processing circuitry 20 therefore may include multiple physical processing devices.

The client application interface 34 is shown in the form of a software plugin and includes a graphical user interface (GUI) 36 by which a user can enter a query 38 and receive a response 40. To this end, the client application interface 34 is configured to communicate with a language model 42, which may be a generative model, such as a trained large language model (LLM), small language model (SLM), or the like. For example, a generative pre-trained transformer model, such as Chat-GPT 5.1, LLaMA, etc., can be used. In some examples, the language model 42 can be a multi-modal model configured to accept text, images, and/or audio as forms of input and configured to generate text, images, and/or audio as output. It will be appreciated that the query 38 may originate from an agent at a search service or via enterprise resource management software, for example. In other examples, the language model 42 can be a model system of multiple different language models of varying complexity or specialized training and a request router of the language model system can route requests to the appropriate model for processing.

For each received query 38, the client application interface 34 may instantiate an orchestration agent 44 included in a client application agentic system 42 to determine a workflow for responding to the query 38. When the query 38 is a tax-related query that requires instantiation of tax agents, the client application interface 34 is configured to call the tax application 26 hosted at the server computing device 12. A tax agent 46 included in the tax application agentic system 28 exposes a Representational State Transfer (REST) application programming interface (API) 48 that enables registration of tax application agents at the client computing device 18 such that the orchestration agent 44 in the client application agentic system 42 can access and direct agents in the tax application agentic system 28 to assist in responding to the tax-related query 38 in a federated manner.

The REST API 48 facilitates setup and registration processes 50 between the client application 32 and the tax application 26, as well as natural language communications 52. Security credentials 54, such as user account information 56, from the client application 32 are matched to user account data 58 in the tax application 26 to authenticate the user and validate access of the client orchestration agent 44 to the tax application agents. It will be appreciated that an open standard protocol, such as Open Authorization (OAuth), may be preferably used for authorization and authentication of the client application 32, i.e., user.

When the client application 32 is authenticated, the tax application 26 sends a description of skills 60 of tax application agents, as well as Uniform Resource Locators (URLs) 62 associated with the different functionalities of the tax application agents. As discussed above, the tax agent 46 has the skills to initiate the REST API 48. Additionally, the tax agent 46 can retrieve product knowledge, retrieve tax configuration information, retrieve tax rates, and set up tax configuration information. A reporting agent 64 is configured to run a platform report, analyze the platform report, and output a summary of the analysis. A test bench agent 66 has the ability to execute a simulated tax scenario as a way of determining a theoretical tax result. These skills are enabled by access to data sources 68, such as user data 68A, server or client data 44B, data from tax applications such as a tax categorization engine 68C, a tax compliance engine 68D (including tax forms 68E), tax research tools, stored report libraries, and the like.

A registry agent 70 in the client application agentic system 42 may register the tax agent 46, the reporting agent 64, and the test bench agent such that they can be called by the client orchestration agent 44. Additionally or alternatively, the tax application agentic system 26 may include a tax orchestration agent 72. Either or both of the orchestration agents 70, 72 may be configured to receive natural language context 74 of the query 38 to determine an intent and select a workflow to accomplish the intent. The workflow may have a plurality of steps, which can be nodes in a directed acyclic graph, and the orchestration agent(s) 70, 72 may dispatch calls to other tax application agents to perform required actions in each step of the workflow. Results from each step are passed to successive steps, to thereby complete the operation requested by the query 38, and return a response 40. It will be appreciated that the natural language context 74 of the query 38 and the response 40 are processed for the client application agentic system 42 and the tax application agentic system 28 by a client language model agent 76 and a tax language model agent 78, respectively.

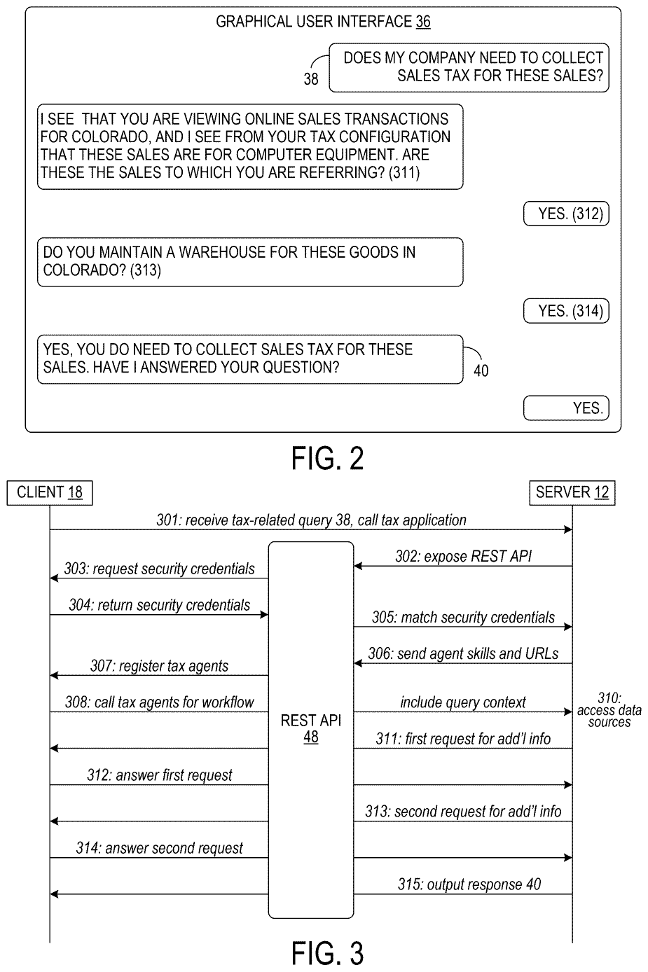

FIG. 2 illustrates an example GUI 36 of the client application interface 34, and FIG. 3 shows related calls between the client computing device 18, server computing device 12, and REST API 48. As shown in FIG. 2, the exchange begins with the user entering a query 38: “Does my company need to collect sales tax for these sales?”

Turning to FIG. 3, at 301, the client application interface 34 receives the tax-related query 38 via the GUI 36 and calls the tax application 26 at the server computing device 12. At 302, the tax agent 46 exposes the REST API 48, which requests security credentials, such as user account information 56, from the client application 32 at 303. The security credentials are returned to the REST API 48 at 304 and matched to the user account data 58 at the tax application 26 at 305. The description 60 of skills of tax application agents and URLs 62 are sent at 306, and the tax application agents are registered with the client orchestration agent 44 at 307. The client orchestration agent 44 determines that to answer this query it needs to instantiate a workflow that calls the tax agent 46 to read user data 68A to determine the user tax configuration in this jurisdiction of Colorado, and send the tax configuration and sales records to the tax compliance engine 68D to thereby determine whether an obligation exists. As such, at 308, the tax agent 46 called to complete the workflow for answering the query 38, and query context 74 is included in the communication.

To answer the example query 38 in FIG. 2, the tax agent 46 accesses data sources 68 to retrieve product knowledge, configuration information, and tax rates at 310. It is determined that more information is needed to answer the query 38, and a first request for additional information is sent to the client application 32 and displayed in the GUI 36, as indicated at 311 in FIGS. 2 and 3. An answer to the first request for additional information is returned, as indicated at 312 in FIGS. 2 and 3. It is determined that additional information is needed to answer the query 38, and second request for additional information is sent to the client application 32 and displayed in the GUI 36, as indicated at 313 in FIGS. 2 and 3. An answer to the second request for additional information is returned, as indicated at 314 in FIGS. 2 and 3. Finally, as indicated at 315 in FIG. 3, a response 40 to the query 38 is output to the client application 32 and displayed in the GUI 36, as shown in FIG. 2

In the example embodiment shown in FIGS. 2 and 3, the client language model agent 76 and the tax language model agent 78 interface with the language model 42 to generate natural language responses that are displayed in the 36.

Returning to FIG. 1, it will be appreciated that the client application agentic system 42 may include a client copilot agent 80 can be provisioned on the client application interface 34, and configured to exchange information in a federated manner with the tax agent 46, or directly via the REST API 48 with the tax application agentic system 28 of tax application 26. In such a configuration, the client application agentic system 34 receives a tax-related query, and, upon determining it is a tax-related query, passes the query 38 to the tax agent 46. In such a configuration the tax agent 46 is preregistered with the client copilot agent 80 to answer tax-related questions, according to the description of skills of the tax agent 46. Thus, the invention disclosed herein provides for registration of tax application agents of tax application 26 at the client application 34, such that the client orchestration agent 44 can access to tax application agent at the tax application 26 to assist in a federated manner in responding to a user's query 38. As yet another example, the copilot agent could be an LLM-enabled search interface, for example. In such a multi-agent federated approach, agents delegate portions of queries to other agents who have registered as experts.

In another example of a federated agent interaction, an agent in an enterprise resource program (ERP) ecosystem communicates with an agent in the tax application agentic system 28 to determine if a proposed business expansion or product change would have an effect in the tax ecosystem. Additionally or alternatively, a shopping cart builder agent in an ERP program can interface with the tax application agentic system 28 of the tax application 26 to determine if a proposed code for a shopping cart will accurately compute tax. In this implementation, the tax application agentic system 28 has access to information on products and localities in the tax compliance engine 68D and other data sources 68, and therefore it can determine whether the shopping cart will work for all products and in all jurisdictions.

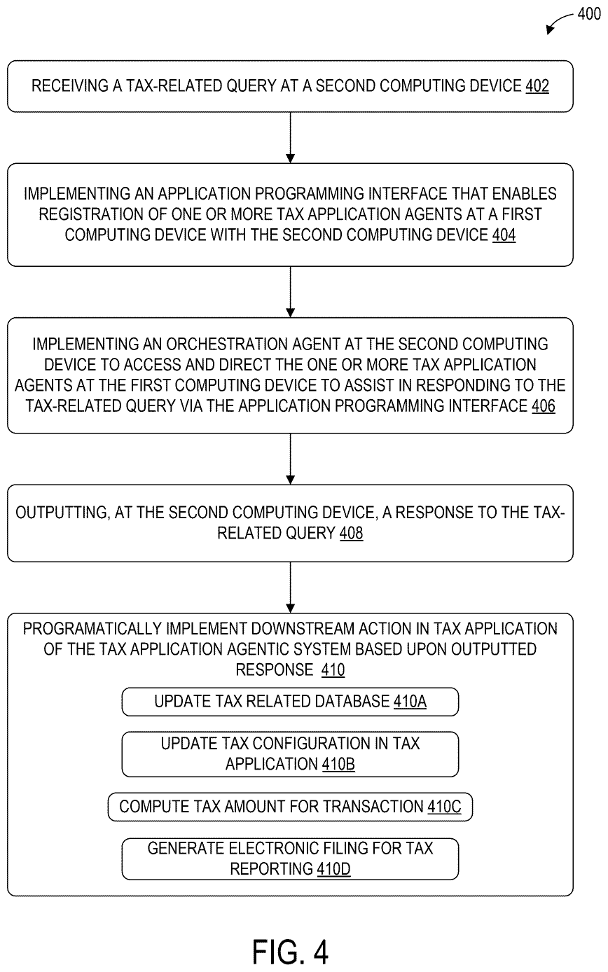

FIG. 4 shows a flowchart for a method 400. The method 400 may be implemented by the computing system 10 illustrated in FIG. 1, or via other suitable hardware and software.

At step 402, the method 400 may include receiving a tax-related query at the second computing device. The tax-related query requiring instantiation of one or more tax application agents included in a tax application agentic system at the first computing device.

Continuing from step 402 to step 404, the method 400 may include implementing an application programming interface that enables registration of the one or more tax application agents at the first computing device with the second computing device. The application programming interface requests security credentials from the client application to authenticate the client application at the second computing device.

Proceeding from step 404 to step 406, the method 400 may include implementing an orchestration agent included in a client application agentic system at the second computing device to access and direct the one or more tax application agents at the first computing device to assist in responding to the tax-related query via the application programming interface. As discussed in detail above, the orchestration agent may receive natural language context of the tax-related query to determine an intent and select a workflow to accomplish the intent. The selected workflow has a plurality of steps, and the orchestration agent may dispatch calls to tax application agents included in the tax application agentic system at the first computing device to perform required actions in each step of the workflow. The tax application may send a description of skills of the one or more tax application agents to the orchestration agent, and a registry agent included in the client application agentic system may register the one or more tax application agents with the second computing device such that the one or more tax application agents can be called by the orchestration agent. The one or more tax application agents is a tax agent, a reporting agent, or a test bench agent that can access data sources including user data, data from a tax categorization engine, data from a tax compliance engine, and tax research tools. For example, the tax agent is configured to retrieve product knowledge, retrieve tax configuration information, retrieve tax rates, and set up tax configuration information.

Advancing from step 406 to step 408, the method 400 may include outputting, at the second computing device, a response to the tax-related query.

As shown at 410, the method 400 may further including programmatically implementing a downstream action in a tax application of the tax application agentic system based upon the outputted response. This action may be taken upon receiving user confirmation that the action is appropriate to take, via the client application. In response to this confirmation, the client application may send a command to the tax application agentic system to perform the downstream action. The command can include all or part of the generated response as a parameter. For example, as shown at 410A, the downstream action can be updating a tax related database, for example with a tax category for a product, or a tax rate for a jurisdiction based on the response, for example. In this example, the database can be a database of a tax categorization engine. As another example, as shown at 410B, the downstream action can be updating a tax configuration for the client entity in the tax application, based on the generated response. For example, the entity size could be updated, or the places of doing business could be updated, or the overall revenue for the entity could be updated, based on the response. As another example shown at 410C, the downstream action can be computing a tax amount for a transaction using a tax calculation engine of the tax application based on the response. For example, the response could include information on the applicability of a tax holiday or an answer to a question on a tax rate to be applied to a product in a shopping cart of a transaction, and the tax amount computed by the tax calculation engine could be generated based on the response. As another example shown at 410D, the downstream action can include generating an electronic filing for tax reporting. For example, the response could include an answer to whether a certain kind of transaction needs to be reported to a particular taxing authority, and based on the answer in the response, the electronic filing could be generated. As another example, a parameter included in the filing, such as tax owed for a transaction, could be reconciled based on the response, and the reconciled amount could be included in the electronic filing. These are but a few practical examples of how a downstream action can be programmatically taken by the tax application based upon the generated response, as numerous other scenarios are possible.

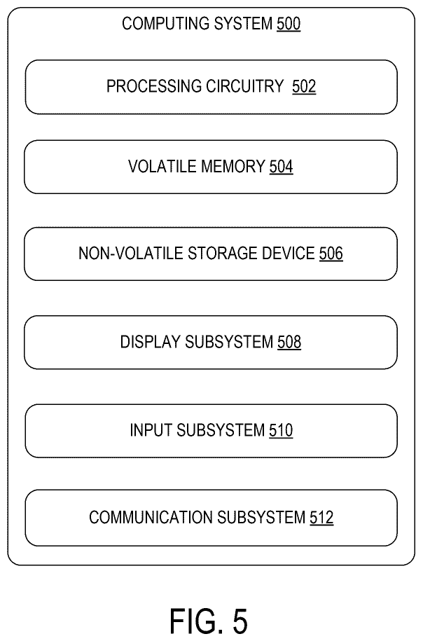

FIG. 5 schematically shows a non-limiting embodiment of a computing system 500 that can enact one or more of the methods and processes described above. Computing system 500 is shown in simplified form. Computing system 500 may embody the computing system 10 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 5.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

The following paragraphs provide additional description of aspects of the present disclosure. One aspect provides a computing system for interfacing a tax application agentic system with a client application agentic system. The computing system may comprise processing circuitry configured to execute instructions using portions of associated memory to implement a tax application on a first computing device and a client application on a second computing device. The processing circuitry may be configured to receive a tax-related query at the second computing device. The tax-related query may require instantiation of one or more tax application agents included in a tax application agentic system at the first computing device. The processing circuitry may implement an application programming interface that enables registration of the one or more tax application agents at the first computing device with the second computing device. The processing circuitry may implement an orchestration agent included in a client application agentic system at the second computing device to access and direct the one or more tax application agents at the first computing device to assist in responding to the tax-related query via the application programming interface. The processing circuitry may output, at the second computing device, a response to the tax-related query.

In this aspect, additionally or alternatively, the orchestration agent may receive natural language context of the tax-related query to determine an intent and select a workflow to accomplish the intent. In this aspect, additionally or alternatively, the selected workflow may have a plurality of steps, and the orchestration agent included in the client application agentic system at the second computing device may dispatch calls to tax application agents included in the tax application agentic system at the first computing device to perform required actions in each step of the workflow. In this aspect, additionally or alternatively, the application programming interface may request security credentials from the client application to authenticate the client application at the second computing device. In this aspect, additionally or alternatively, the tax application may send a description of skills of the one or more tax application agents included in the tax application agentic system at the first computing device to the orchestration agent included in the client application agentic system at the second computing device. In this aspect, additionally or alternatively, a registry agent included in the client application agentic system may register the one or more tax application agents included in the tax application agentic system at the first computing device with the second computing device such that the one or more tax application agents can be called by the orchestration agent at the second computing device. In this aspect, additionally or alternatively, the one or more tax application agents may be a tax agent, a reporting agent, or a test bench agent. In this aspect, additionally or alternatively, the tax agent may be configured to retrieve product knowledge, retrieve tax configuration information, retrieve tax rates, and set up tax configuration information. In this aspect, additionally or alternatively, the one or more tax application agents may be configured to access data sources including user data, data from a tax categorization engine, data from a tax compliance engine, and tax research tools.

Another aspect provides a computing method for interfacing a tax application agentic system with a client application agentic system. The method may comprise receiving a tax-related query at a second computing device. The tax-related query may require instantiation of one or more tax application agents included in a tax application agentic system at a first computing device. The method may further comprise implementing an application programming interface that enables registration of the one or more tax application agents at the first computing device with the second computing device. The method may further comprise implementing an orchestration agent included in a client application agentic system at the second computing device to access and direct the one or more tax application agents at the first computing device to assist in responding to the tax-related query via the application programming interface. The method may further comprise outputting, at the second computing device, a response to the tax-related query.

In this aspect, additionally or alternatively, the method may further comprise receiving, by the orchestration agent, natural language context of the tax-related query to determine an intent and select a workflow to accomplish the intent. In this aspect, additionally or alternatively, the selected workflow may have a plurality of steps, and the method may further comprise dispatching, by the orchestration agent included in the client application agentic system at the second computing device, calls to tax application agents included in the tax application agentic system at the first computing device to perform required actions in each step of the workflow. In this aspect, additionally or alternatively, the method may further comprise requesting, by the application programming interface, security credentials from the client application to authenticate the client application at the second computing device. In this aspect, additionally or alternatively, the method may further comprise sending, by the tax application, a description of skills of the one or more tax application agents included in the tax application agentic system at the first computing device to the orchestration agent included in the client application agentic system at the second computing device. In this aspect, additionally or alternatively, the method may further comprise registering, by a registry agent included in the client application agentic system, the one or more tax application agents included in the tax application agentic system at the first computing device with the second computing device such that the one or more tax application agents can be called by the orchestration agent at the second computing device. In this aspect, additionally or alternatively, the one or more tax application agents may be a tax agent, a reporting agent, or a test bench agent. In this aspect, additionally or alternatively, the method may further comprise configuring the tax agent to retrieve product knowledge, retrieve tax configuration information, retrieve tax rates, and set up tax configuration information. In this aspect, additionally or alternatively, the method may further comprise accessing, by the one or more tax application agents, data sources including user data, data from a tax categorization engine, data from a tax compliance engine, and tax research tools. In this aspect, additionally or alternatively, the method may further comprise programmatically implementing a downstream action in the tax application agentic system, based on the outputted response.

Another aspect provides a computing system for interfacing a tax application agentic system with a client application agentic system. The computing system may comprise processing circuitry configured to execute instructions using portions of associated memory to implement a tax application on a first computing device and a client application on a second computing device. The processing circuitry may be configured to receive a tax-related query at the second computing device. The tax-related query may require instantiation of one or more tax application agents included in a tax application agentic system at the first computing device. The processing circuitry may implement an application programming interface that enables registration of the one or more tax application agents at the first computing device with the second computing device. The application program interface may be configured to requests security credentials from the client application to authenticate the client application at the second computing device. The processing circuitry may be configured to configure an orchestration agent included in a client application agentic system at the second computing device to receive natural language context of the tax-related query to determine an intent and select a workflow to accomplish the intent. The processing circuitry may be configured to implement the orchestration agent at the second computing device to dispatch calls to tax application agents included in the tax application agentic system at the first computing device to perform required actions in each step of the workflow. The processing circuitry may be configured to output, at the second computing device, a response to the tax-related query.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for interfacing a tax application agentic system with a client application agentic system, comprising:
processing circuitry configured to execute instructions using portions of associated memory to implement a tax application on a first computing device and a client application on a second computing device, the processing circuitry being configured to:
receive a tax-related query at the second computing device, the tax-related query requiring instantiation of one or more tax application agents included in a tax application agentic system at the first computing device;
implement an application programming interface that enables registration of the one or more tax application agents at the first computing device with the second computing device;
implement an orchestration agent included in a client application agentic system at the second computing device to access and direct the one or more tax application agents at the first computing device to assist in responding to the tax-related query via the application programming interface; and
output, at the second computing device, a response to the tax-related query.

2. The computing system of claim 1, wherein
the orchestration agent receives natural language context of the tax-related query to determine an intent and select a workflow to accomplish the intent.

3. The computing system of claim 2, wherein
the selected workflow has a plurality of steps, and
the orchestration agent included in the client application agentic system at the second computing device dispatches calls to tax application agents included in the tax application agentic system at the first computing device to perform required actions in each step of the workflow.

4. The computing system of claim 1, wherein
the application programming interface requests security credentials from the client application to authenticate the client application at the second computing device.

5. The computing system of claim 1, wherein
the tax application sends a description of skills of the one or more tax application agents included in the tax application agentic system at the first computing device to the orchestration agent included in the client application agentic system at the second computing device.

6. The computing system of claim 1, wherein
a registry agent included in the client application agentic system registers the one or more tax application agents included in the tax application agentic system at the first computing device with the second computing device such that the one or more tax application agents can be called by the orchestration agent at the second computing device.

7. The computing system of claim 1, wherein
the one or more tax application agents is a tax agent, a reporting agent, or a test bench agent.

8. The computing system of claim 7, wherein
the tax agent is configured to retrieve product knowledge, retrieve tax configuration information, retrieve tax rates, and set up tax configuration information.

9. The computing system of claim 1, wherein
the one or more tax application agents is configured to access data sources including user data, data from a tax categorization engine, data from a tax compliance engine, and tax research tools.

10. A computing method for interfacing a tax application agentic system with a client application agentic system, the method comprising:
receiving a tax-related query at a second computing device, the tax-related query requiring instantiation of one or more tax application agents included in a tax application agentic system at a first computing device;
implementing an application programming interface that enables registration of the one or more tax application agents at the first computing device with the second computing device;
implementing an orchestration agent included in a client application agentic system at the second computing device to access and direct the one or more tax application agents at the first computing device to assist in responding to the tax-related query via the application programming interface; and
outputting, at the second computing device, a response to the tax-related query.

11. The method of claim 10, the method further comprising:
receiving, by the orchestration agent, natural language context of the tax-related query to determine an intent and select a workflow to accomplish the intent.

12. The method of claim 11, wherein
the selected workflow has a plurality of steps, and
the method further comprises dispatching, by the orchestration agent included in the client application agentic system at the second computing device, calls to tax application agents included in the tax application agentic system at the first computing device to perform required actions in each step of the workflow.

13. The method of claim 10, the method further comprising:
requesting, by the application programming interface, security credentials from the client application to authenticate the client application at the second computing device.

14. The method of claim 10, the method further comprising:
sending, by the tax application, a description of skills of the one or more tax application agents included in the tax application agentic system at the first computing device to the orchestration agent included in the client application agentic system at the second computing device.

15. The method of claim 10, the method further comprising:
registering, by a registry agent included in the client application agentic system, the one or more tax application agents included in the tax application agentic system at the first computing device with the second computing device such that the one or more tax application agents can be called by the orchestration agent at the second computing device.

16. The method of claim 10, wherein
the one or more tax application agents is a tax agent, a reporting agent, or a test bench agent.

17. The method of claim 16, the method further comprising:
configuring the tax agent to retrieve product knowledge, retrieve tax configuration information, retrieve tax rates, and set up tax configuration information.

18. The method of claim 10, the method further comprising:
accessing, by the one or more tax application agents, data sources including user data, data from a tax categorization engine, data from a tax compliance engine, and tax research tools.

19. The method of claim 10, the method further comprising:
programmatically implementing a downstream action in the tax application agentic system, based on the outputted response.

20. A computing system for interfacing a tax application agentic system with a client application agentic system, comprising:
processing circuitry configured to execute instructions using portions of associated memory to implement a tax application on a first computing device and a client application on a second computing device, the processing circuitry being configured to:
receive a tax-related query at the second computing device, the tax-related query requiring instantiation of one or more tax application agents included in a tax application agentic system at the first computing device;
implement an application programming interface that enables registration of the one or more tax application agents at the first computing device with the second computing device, the application program interface being configured to requests security credentials from the client application to authenticate the client application at the second computing device;
configure an orchestration agent included in a client application agentic system at the second computing device to receive natural language context of the tax-related query to determine an intent and select a workflow to accomplish the intent;
implement the orchestration agent at the second computing device to dispatch calls to tax application agents included in the tax application agentic system at the first computing device to perform required actions in each step of the workflow; and
output, at the second computing device, a response to the tax-related query.
